(19) United States
(12) Patent Application Publication
(10) Pub. No.: US 2025/0056343 A1
(43) Pub. Date: Feb. 13, 2025

(54) MOBILITY ROBUSTNESS OPTIMIZATION

(71) Applicant: Nokia Technologies Oy, Espoo (FI)

(72) Inventors: Ahmad AWADA, Munich (DE); Bernhard WEGMANN, Holzkirchen (DE); Guillaume DECARREAU, Munich (DE); Irina-Mihaela BALAN, Munich (DE); Ugur Baran ELMALI, Munich (DE); Sina KHATIBI, Munich (DE)

(21) Appl. No.: 18/719,984

(22) PCT Filed: Dec. 20, 2021
(86) PCT No.: PCT/EP2021/086799

§ 371 Date: Jun. 14, 2024

(51) Int. Cl. H04W 36/00; H04W 36/36

(52) U.S. Cl. CPC H04W 36/0079; H04W 36/0058; H04W 36/362

(57) ABSTRACT

A method detecting at least one of a mobility failure and a respective successful handover; determining a type of the mobility failure, wherein the type of the mobility failure is determined in response to the detected mobility failure; generating mobility failure information indicative of one or more parameters associated with the type of mobility failure, wherein the mobility failure information is generated, at least in part, based on the determined type of the mobility failure; and providing the mobility failure information and/or successful handover information including, at least in part, one or more parameters associated with the respective successful handover, wherein mobility failure information and/or successful handover information enable a network to determine whether a root cause associated with at least one of a respective mobility failure information and a respective successful handover information is a misconfiguration of one or more parameters controlling L3 handover procedures or L1/2 inter-cell mobility.

### FIELD

The following disclosure relates to the field of mobility robustness optimization (MRO), or more particularly relates to systems, apparatuses, and methods for providing information associated with handover procedures in mobile communication networks for performing and/or controlling mobility robustness optimization.

### BACKGROUND

In networks, e.g. cellular network, mobile communication networks, or radio access networks, a user equipment (UE) may be connected to a network node. The network node may for instance be an evolved NodeB (eNB) in a cellular network providing long term evolution (LTE) functionality and/or a 5G NodeB (gNB) in a cellular network providing 5G functionality.

For various reasons, the connection between a UE and a network node may be interrupted. One example reason is mobility of a UE, i.e. users and their user equipment (UE) may move through cellular networks. This mobility may cause situations where the UE may need to change its connection from a serving node to a target node. This is referred to as handover.

Mobility Robustness Optimization (MRO) use cases of so-called Self-Organizing Network(s) (SON) deal with the (e.g. automatic) optimization of parameters controlling UE mobility (e.g. handovers respective handover procedures). In general, there are different types of mobility failures, e.g. failures in relation to Layer 3 (L3) mobility procedures and failures in relation to L1/2 centric mobility.

### SUMMARY OF SOME EXEMPLARY EMBODIMENTS

Inter alia, an object to enhance MRO, in particular provides a solution enabling a network that does not have information needed when a UE context is gone to analyze undesired events or mobility failures of a respective UE associated with mobility procedures, to e.g. categorize a mobility failure type and/or to make proper adjustments of parameters controlling L1/L2 mobility to avoid such mobility failures and/or undesired events in future.

According to a first exemplary aspect, a method is disclosed, the method comprising:
detecting at least one of a mobility failure and a respective successful handover;
determining a type of the mobility failure, wherein the type of the mobility failure is determined in response to the detected mobility failure;
generating mobility failure information indicative of one or more parameters associated with the type of the mobility failure, wherein the mobility failure information is generated, at least in part, based on the determined type of the mobility failure; and
providing the mobility failure information and/or successful handover information comprising, at least in part, one or more parameters associated with the respective successful handover, wherein the mobility failure information and/or the successful handover information enable a network to determine whether a root cause associated with at least one of a respective mobility failure information and a respective successful handover information is a misconfiguration of one or more parameters controlling L3 handover procedures or L1/2 inter-cell mobility.

This method may for instance be performed and/or controlled by an apparatus, for instance a user equipment (UE). For instance, the method may be performed and/or controlled by using at least one processor of the UE.

The user equipment (UE) according to the first exemplary aspect as described above will also be referred to as the apparatus according to the first exemplary aspect in the following. It may be a UE of a cellular network, for instance a 3G, LTE/4G, 5G NR, 5G or 6G network. Further, it may be a mobile device, e.g. a handset, a smartphone, a tablet, a laptop, or any other mobile device. In various embodiments, it may be a vehicle for travelling in air, water, or on land, e.g. a plane or a drone, a ship or a car or a truck. It may also be a robot, a sensor device, a wearable device, an Internet of Things (IoT) device, a Machine Type Communication (TC) device, or the likes. Herewith and in the following, the term user equipment is used for such disclosed example apparatuses of the first exemplary aspect.

According to a second exemplary aspect, a method is disclosed, the method comprising:
being provided with at least one of one or more pieces of mobility failure information indicative of one or more parameters associated with a type of a mobility failure, and one or more pieces of successful handover information comprising, at least in part, one or more parameters associated with a respective successful handover, wherein at least one of a respective mobility failure information and/or a respective successful handover information enable the apparatus to determine whether a root cause associated with at least one of a respective mobility failure information and a respective successful handover information is a misconfiguration of one or more parameters controlling L3 handover procedures or L1/2 inter-cell mobility;
determining whether a cause associated with at least one of a respective mobility failure information and a respective successful handover information is a misconfiguration of one or more parameters controlling L3 handover procedures or L1/2-inter-cell mobility; and
determining adjusted one or more parameters to be used for an upcoming L1/2-inter-cell or L3 handover procedure, wherein the adjusted one or more parameters are determined dependent upon the determined cause.

This method may for instance be performed and/or controlled by an apparatus, for instance a network node. For instance, the method may be performed and/or controlled by using at least one processor of the network node. This method may be performed and/or controlled by more than one apparatus, e.g. at least two network nodes. Herewith and in the following, the term network node is used for such disclosed example apparatuses of the second exemplary aspect.

The network node according to the second exemplary aspect may act as a serving node in various embodiments and may thus be referred to as serving node. The network node according to the second exemplary aspect may act as a centralized unit (CU) in various embodiments and may thus be referred to as CU. The network node according to the second exemplary aspect may act as a distributed unit (DU) in various embodiments and may thus be referred to as DU.

According to a further exemplary aspect, a computer program is disclosed, the computer program when executed by a processor causing an apparatus, for instance a server, to perform and/or control the actions of the method according to the first and/or exemplary aspect.

The computer program may be stored on computer-readable storage medium, in particular a tangible and/or non-transitory medium. The computer readable storage medium could for example be a disk or a memory or the like. The computer program could be stored in the computer readable storage medium in the form of instructions encoding the computer-readable storage medium. The computer readable storage medium may be intended for taking part in the operation of a device, like an internal or external memory, for instance a Read-Only Memory (ROM) or hard disk of a computer, or be intended for distribution of the program, like an optical disc.

According to a further exemplary aspect, an apparatus is disclosed, configured to perform and/or control or comprising respective means for performing and/or controlling the method according to the first and/or second exemplary aspect.

The means of the apparatus can be implemented in hardware and/or software. They may comprise for instance at least one processor for executing computer program code for performing the required functions, at least one memory storing the program code, or both. Alternatively, they could comprise for instance circuitry that is designed to implement the required functions, for instance implemented in a chipset or a chip, like an integrated circuit. In general, the means may comprise for instance one or more processing means or processors.

According to a further exemplary aspect, an apparatus is disclosed, comprising at least one processor and at least one memory including computer program code, the at least one memory and the computer program code configured to, with the at least one processor, cause an apparatus, for instance the apparatus, at least to perform and/or to control the method according to the first and/or second exemplary aspect.

The above-disclosed apparatus according to any aspect may be a module or a component for a device, for example a chip. Alternatively, the disclosed apparatus according to any aspect may be a device, for instance a server or server cloud. The disclosed apparatus according to any aspect may comprise only the disclosed components, for instance means, processor, memory, or may further comprise one or more additional components.

Additionally, a system is disclosed, the system comprising at least two apparatuses, e.g. comprising a UE according to the first exemplary aspect, and a network node according to the second exemplary aspect.

Any disclosure herein relating to any exemplary aspect is to be understood to be equally disclosed with respect to any subject-matter according to the respective exemplary aspect, e.g. relating to an apparatus, a method, a computer program, and a computer-readable medium. Thus, for instance, the disclosure of a method step shall also be considered as a disclosure of means for performing and/or configured to perform the respective method step. Likewise, the disclosure of means for performing and/or configured to perform a method step shall also be considered as a disclosure of the method step itself. The same holds for any passage describing at least one processor; and at least one memory including computer program code; the at least one memory and the computer program code configured to, with the at least one processor, cause an apparatus at least to perform a step.

For convenience, a list of abbreviations used in the following is already given at this point:
AMF Access and Mobility Management Function
CBRA Contention-Based Random Access
CFRA Contention-Free Random Access
CHO Conditional Handover
CU Centralized Unit
DAPS Dual Active Protocol Stack
DU Distributed Unit
gNB Next generation NodeB
HO Handover
HWC Handover to wrong cell
KPI Key Performance Indicator
MAC Medium Access Control
MME Mobility Management Entity
MRO Mobility Robustness Optimization
Near RT RIC Near Real-Time RAN Intelligent Controller
OAM Operation, Administration, and Management
O-RAN Open Radio Access Network
PDCP Packet Data Convergence Protocol
PHY Physical Layer
RAN Radio Access Network
RAR Random Access Response
RIC RAN Intelligent Controller
RLC Radio Link Control
RLF Radio Link Failure
RRC Radio Resource Control
SHR Successful Handover Report
TS Technical Specification
UE User Equipment
UPF User Plane Function

In the following, exemplary features and example embodiments of all exemplary aspects will be described in further detail.

Example embodiments of all exemplary aspects target missing functionalities and missing failure related information to carry out a proper root cause analysis for failures occurring for or in association with handover procedures, in particular L1/2 inter-cell changes. Those functionalities and information may allow to enhance MRO and to optimize at a respective cell-border individually or at e.g. all cell-borders one or more parameters for L1/2 inter-cell mobility, in particular L1/2 initiated inter-cell mobility e.g. for a respective UE of the first exemplary aspect.

Example embodiments of all exemplary aspects may allow to address, among other things, 1) differentiating mobility failures caused by a misconfiguration of parameters controlling L1/2 inter-cell mobility and L3 inter-cell mobility procedures (e.g. baseline HO, CHO and DAPS HO), and/or 2) missing information for optimizing L1/2 inter-cell mobility. Such failures or undesired events may arise due to the fact that a network node (e.g. serving node or source node of a handover procedure) may not have respective UE context anymore, when it receives mobility failure information (e.g. logging information, RLF report or successful HO report) and/or successful handover information (e.g. in the form of successful handover report(s)) from the respective UE. The respective UE may have been provided UE context that is kept at least for a certain amount of time in a respective source cell hosted by a respective network node (e.g. serving cell of the respective UE prior to the UE being handed over to a target cell, which is the serving cell of the respective UE after a successful HO).

For instance, in case of too-late handover (TLH) cases from a source cell A to a target cell B, the source cell A may not have the UE context (e.g. depending on the network implementation) upon receiving a RLF report from another network node (e.g. that fetched the report, e.g. from a respective UE of the first exemplary aspect). This may happen for instance if the RLF report is not fetched immediately by the network (e.g. network node) and the source cell has deleted the UE context. Such UE context typically holds (e.g. all) information about UE measurement configuration, e.g. which MeasID is foreseen for which mobility mode, to name but a few non-limiting examples. In this case, the source cell may not determine from the information it is provided with or that is comprised by the RLF report whether the TLH is caused by misconfiguration of one or more parameters controlling L1/2 inter-cell mobility or L3 inter-cell mobility (such as baseline HO, CHO and DAPS HO). Thus, MRO would not be beneficial since the respective network node performing and/or controlling the optimization may not have (e.g. all) the necessary information (e.g. measurement quantities of the configured MeasIDs) to optimize the respective L1/2 inter-cell mobility parameter(s).

The same may happen in case of too-early handover (THE) or handover to wrong cell (HWC) cases. For instance, handover from cell A to B and (e.g. shortly) after the UE detects a mobility failure (e.g. a RLF) and reconnects to cell A (THE case), or is handed over to wrong cell (HWC case). The respective network node fetching the RLF report may provide (e.g. send) the respective mobility failure information (e.g. RLF report) to cell B, which in turn forwards it to cell A using a successful handover information (e.g. successful handover report message). Cell A may store the UE context for some time (e.g. Tstore_UE_cntxt) after the handover is successfully completed. In case the successful handover information is not obtained (e.g. retrieved) immediately, the respective serving cell A may not have the UE context (depending on the network implementation) and as such, may not have the necessary information to determine whether the TEH or HWC is caused by misconfiguration of the L3 (e.g. BHO, CHO, DAPS HO) or L1/2 inter-cell related mobility parameters. In addition, the current serving cell of the respective UE would not have (e.g. all) the information to optimize the L1/2 inter-cell mobility parameters, as the UE context may have been released already.

By network implementation, cell A may encode some information about the UE context (e.g. if L1/2 or L3 inter-cell mobility is prepared for the UE, for instance) that is forwarded (e.g. passed) to cell B, e.g. by using a Mobility Information Information Element (IE) in a respective Handover Request message. Such a Mobility Information may be relayed back from cell B to cell A using a Handover Report in case of TEH and HWC. Using this information, cell A may obtain (e.g. retrieve) some encoded information about the UE context. Yet, it is not clear to which extent Mobility Information can then be used to obtain (e.g. retrieve) information about the UE context. The UE context may be limited to a 32 bit OCTET and was designed to enable group-based MRO, i.e., encode the group to which the UE belongs to. In other words, it may not be clear how the respective Mobility Information IE can be used to encode for instance one or more (e.g. prepared) target cells for L1/2 inter-cell mobility, the reporting configuration of the beam measurements, to name but a few non-limiting examples.

Example embodiments of all exemplary aspects may provide to detect a mobility failure, determine a type of the mobility failure, generating mobility failure information indicative of one or more parameters associated with the type of the mobility failure, and provide the mobility failure information. Further, example embodiments of all exemplary aspects may provide to detect a successful handover, and provide successful handover information comprising, at least in part, one or more parameters associated with the handover. The one or more parameters associated with the handover may be one or more parameters controlling how a respective UE performs and/or controls a mobility procedure, e.g. a handover. Based on the one or more parameters associated with the handover, it is determinable whether an undesired event occurred in conjunction with the handover. Such an undesired event may be associated with a mobility procedure. For instance, in case a successful handover is performed by a respective UE, the respective UE may still have performed the successful handover in an undesired way, e.g. by a too early preparation event of a candidate target cell. When this occurs, one or more parameters controlling L3 handover procedures or L1/2 mobility on part of the respective UE may be adjusted e.g. to optimize MRO.

The mobility failure information may be provided in a dedicated information (e.g. message) enabling to ensure MRO can be relied upon information actually present in the network and that may be associated with the respective detected mobility failure.

Mobility failure, as used herein and of all exemplary aspects, may be understood as a radio link failure. The mobility failure may have been occurred in association with a handover or mobility procedure, in particular an inter-cell handover or mobility procedure. “In association with” may be understood to mean that the mobility failure may have been occurred prior, during or after a handover or mobility procedure. The mobility failure may be subject to a radio link failure between the respective UE and a serving cell, e.g. a source cell serving the respective UE prior to a mobility or handover procedure, and/or a target cell serving the respective UE after to a mobility or handover procedure.

The respective UE of the first exemplary aspect comprises means for detecting that such a mobility failure has occurred, in particular in in association with a handover or mobility procedure.

If the respective UE of the first exemplary aspect has detected a respective mobility failure, the type of the mobility failure is determined, e.g. by determining the mobility failure based on UE context (e.g. information), e.g. with which the respective UE may have been configured. Such UE context may be related to L1/2 mobility of the respective UE. Such UE context may be comprised by the determined mobility failure information. Thus, the type of the mobility failure is determined in response to the detected mobility failure.

In response to the determined mobility failure, the mobility failure information is generated. The respective UE of the first exemplary aspect comprises respective means for generating mobility failure information. The mobility failure information is indicative of one or more parameters associated with the type of the mobility failure. The mobility failure information may be or be part of an RLF report. Such an RLF report may be provided by the respective UE of the first exemplary aspect e.g. to a network node (e.g. of the second exemplary aspect) in response to the detecting of the mobility failure.

The respective UE of the first exemplary aspect comprises means for detecting that a successful handover has occurred.

If the respective UE of the first exemplary aspect has detected a respective successful handover, it may store e.g. UE context (e.g. information), e.g. with which the respective UE may have been configured. Such UE context may be related to L1/2 mobility of the respective UE.

In response to the successful handover, the UE of the first exemplary aspect may provide successful handover information. The successful handover information may be indicative of one or more parameters associated with or controlling L3 handover procedures or L1/2 mobility on part of the respective UE. The successful handover information may comprise the UE context, as disclosed above. The successful handover information may be or be part of a successful handover report. Such a successful handover report may be provided by the respective UE of the first exemplary aspect e.g. to a network node (e.g. of the second exemplary aspect) in response to the detecting of the successful handover.

The mobility failure information is generated, at least in part, based on the determined type of the mobility failure. This may allow that the mobility failure information comprises or represents that e.g. UE context or one or more parameters configuring L1/2 mobility of the respective UE. Since the respective UE may hold such information, by generating a mobility failure information or by storing it in case that a successful handover is detected, it may be enabled to provide such information to the network, e.g. to the network node of the second exemplary aspect. The respective UE of the first exemplary aspect may generate the mobility failure information and e.g. store them in a memory, e.g. a database, e.g. that may be comprised by or connectable to the respective UE. This may allow to provide the network (respectively the network node of the second exemplary aspect) with information associated with a L1/2 mobility or L3 handover procedure even if e.g. a RLF report is not fetched immediately by the network (e.g. network node) and e.g. a source cell of the respective UE of a respective mobility or handover procedure may have already deleted the respective UE context.

The respective UE of the first exemplary aspect comprises means for providing (e.g. sending) the mobility failure information and/or the successful handover information, e.g. to the network. The network may be an entity of a network. The network may be represent by one or more network nodes of the second exemplary aspect. The mobility failure information may be provided directly after the respective mobility failure information is generated. In this case, the providing may be performed and/or controlled by the respective UE. The providing may be initiated by the respective UE. In addition or in the alternative, the respective UE of the first exemplary aspect may provide the mobility failure information in response to a trigger (e.g. a request) that the respective UE receives. Such a trigger (e.g. request) may be sent by the network node of the second exemplary aspect to the respective UE of the first exemplary aspect, to name but one non-limiting example.

According to an example embodiment of the first exemplary aspect, the method further comprises:
receiving a handover command indicative of a L1/2 inter-cell change; and/or
receiving a reconfiguration information indicative of one or more parameters controlling L1/2 mobility procedure; and/or
receiving a handover command indicative of one or more parameters controlling L3 mobility procedure.

The handover command may for instance be received from a serving cell of the respective UE according to the first exemplary aspect. The handover command may initiate that the respective UE according to the first exemplary aspect becomes connected to a target cell. The handover command may initiate that the respective UE according to the first exemplary aspect becomes disconnect from the serving cell or releases the serving cell hosted by a respective network node of the second exemplary aspect, for instance. The disconnecting may be performed and/or controlled e.g. after the respective UE according to the first exemplary aspect becomes connected to the target cell.

For initiating that the respective UE according to the first exemplary aspect performs and/or controls a change from its serving cell to a target cell, the reconfiguration information may be received by the respective UE. The reconfiguration information may be a RRC Reconfiguration message. The reconfiguration information may be indicative of one or more parameters controlling L1/2 mobility of the respective UE. For instance, the one or more parameters controlling L1/2 mobility may be one or more parameters associated with L1/2 inter-cell mobility procedure/handover. The one or more parameters controlling L1/2 mobility may be one or more parameters provided by a network node (e.g. the network node according to the second exemplary aspect) to the respective UE of the first exemplary aspect so that the respective UE is or can be configured with the L1/2 inter-cell mobility or L3 handover procedures. For instance, the reconfiguration information may comprise or represent a configuration and/or one or more parameters of one or more target cells for the L1/2 inter-cell mobility procedure. This may allow the respective UE of the first exemplary aspect to be handed over (thus, become connected to at least one of the target cells as configured by the one or more parameters, and become disconnected from its current serving cell).

The respective UE according to the first exemplary aspect may in addition or in the alternative to the two aforementioned cases receive a handover command indicative of one or more parameters controlling L3 mobility procedure.

For one or more of these purposes, in example embodiments of all exemplary aspects, the respective UE of the first exemplary aspect may be configured so that it can generate mobility failure information, e.g. by logging one or more different Information Element(s) (IE(s)) depending on the determined type of failure.

According to an example embodiment of the first exemplary aspect, for the determining of the type of the mobility failure and/or in case of a detected successful handover, the method further comprises one or more of:
i) determining if the mobility failure occurred in a serving cell with no handover command received by the apparatus and prior to the detecting of the mobility failure; and/or
ii) determining if the mobility failure occurred after a handover command is received by the apparatus; and/or
iii) determining if a successful cell change occurred after receiving a handover configuration.

The respective UE of the first exemplary aspect may determine the type of mobility failure, e.g. by determining if the mobility failure occurred in a serving cell with no handover command received by the apparatus and prior to the detecting of the mobility failure. Such a type of mobility failure may have been occurred, if the mobility failure (e.g. RLF) occurs in the serving cell with no (L1 or L3) cell change order (handover command) received by the respective UE of the first exemplary aspect. This case i) may also be referred to as TLH case.

In addition or in the alternative, the respective UE of the first exemplary aspect may determine the type of mobility failure, e.g. by determining if the mobility failure occurred in a target cell after a handover command is received by the respective UE of the first exemplary aspect. For instance, the respective mobility failure may have been occurred (e.g. shortly) after a handover command is received by the respective UE of the first exemplary aspect. “Shortly” in this context may be understood as a time period of e.g. 3 s or 5 s. Such a type of mobility failure may have been occurred, if the mobility failure occurs (e.g. in the target cell) after receiving a (L1 or L3) cell change order (e.g. handover command). This case ii) may also be referred to as TEH and/or HWC cases.

Further, it may be determined if a successful cell change (handover) occurred after receiving a handover configuration. If, however after a successful cell change, it is determined that the successful handover happened too early (TEH case), or it is determined that the successful handover was performed to a wrong cell (HWC case, e.g. cell having a worse signal strength than another cell, to name but one non-limiting example), although a successful handover was performed, the TEH case and/or the HWC case are not desired. If such a TEH case and/or HWC case occurs, one or more parameters controlling mobility may be determined such that respective TEH and/or HWC cases may occur less or not at all in future (and e.g. similar) situations). This case may be considered as an undesired event which is either detected while performing random access to a target cell (TEH case) or after the handover has been completed (in addition or in the alternative, the respective UE may detect a mobility failure (e.g. shortly) after the (e.g. successful) handover). In this case, TEH case or HWC case may be present, depending on whether the respective UE re-establishes to a same source cell A or to a new target cell C (different from the previous target cell B). Further, a duration or time between a reception of the RRC message and the undesired event (failure) may be logged.

According to an example embodiment of the first exemplary aspect, wherein in case type i) is determined, the generated mobility failure information comprises, at least in part, one or more of the following:
i.a) an indication whether the apparatus was configured with one or more parameters for L1/2 inter-cell mobility;
i.b) one or more physical cell IDs, PCI, of one or more target cells for L1/2 inter-cell mobility;
i.c) one or more pieces of beam measurement information for the serving cell and optionally, for the one or more target cells;
i.d) an indication whether a conditional handover (CHO), is or was configured in addition to L1/2 inter-cell mobility;
ie) one or more L1 measurements for a serving cell and for one or more prepared target cells, if any, that are prepared for L1/2 inter-cell mobility on part of the apparatus.

In case i.a), the respective UE of the first exemplary aspect may generate the mobility failure information such that the mobility failure information comprises or represents, at least in part, whether the respective UE was configured with one or more prepared target cells e.g. for L1/2 centric inter-cell mobility, e.g. when the mobility failure occurred. Further, the mobility failure information may further comprise or represent, at least in part, whether the respective UE of the first exemplary aspect has received an RRC Reconfiguration (e.g. message) for a target cell for L1/2 centric inter-cell mobility. The mobility failure information may further comprise or represent at least in part one or more PCIs of the one or more prepared cells for L1/2 centric mobility.

In case i.b), the respective UE of the first exemplary aspect may generate the mobility failure information such that the mobility failure information comprises or represents, at least in part, one or more physical cell IDs, PCI, of one or more target cells for L1/2 inter-cell mobility

In case i.d), the respective UE of the first exemplary aspect may generate the mobility failure information such that the mobility failure information comprises or represents, at least in part, whether the respective UE was configured with L3 CHO in addition to L1/2 centric inter-cell mobility or not.

In case i.c), the respective UE of the first exemplary aspect may generate the mobility failure information such that the mobility failure information comprises or represents, at least in part, whether the respective UE of the first exemplary aspect is or was configured to report L1 measurements (e.g. CSI/CQI reporting) in periodic or aperiodic manner, whether the respective UE of the first exemplary aspect is or was configured with one or more prepared target cells, which one or more radio signals (RS) is used for L1 measurements (SSB-RS or CSI-RS), measured quantity (L1-RSRP, L1-SINR, RSRQ), number N of L1 reported measurements, N strongest L1 measurements for serving and non-serving serving cells, or a combination thereof, to name but a few non-limiting examples. The network, e.g. the network node of the second exemplary aspect may use such a mobility failure information e.g. to determine if the respective mobility failure was caused by a too long reporting periodicity, or for instance if the configured period is too long, to name but a few non-limiting example. In the latter case, respective shortening of the periodicity interval or the period may optimize the mobility robustness.

Thus, MRO can be performed and/or controlled e.g. by adjusting respective adapting the measurement reporting periodicity to occur more often or frequent, to name but one non-limiting example.

In case i.e), the respective UE of the first exemplary aspect may generate the mobility failure information such that the mobility failure information comprises or represents, at least in part, one or more L1 measurements e.g. for the serving cell and for the one or more target cells (if any) that are prepared for L1/2 inter-cell mobility, e.g. on part of the respective UE of the first exemplary aspect.

According to an example embodiment of the first exemplary aspect, wherein in case type ii) is determined, the generated mobility failure information comprises, at least in part:
ii.a) an indication whether a handover command is or was triggered by a L1/2- or a L3-mobility procedure; and
ii.b) an indication about a time duration between the reception of a handover command triggering L1 inter-cell mobility execution until the detection of the mobility failure.

In mobility failure type ii), the respective mobility failure may have been occurred (e.g. shortly) after receiving a (e.g. L1 or L3) cell change order (e.g. handover command), in TEH and HWC cases.

For a case ii.a), the generated mobility failure information may comprise or represent, at least in part, if the respective handover from a (e.g. source or serving) cell A to another (e.g. target) cell B (preceding the respective mobility failure (e.g. RLF) in cell B) is or was triggered by L3 mobility procedure. This may apply to the respective handover being a BHO, CHO, or DAPS HO. Additionally or alternatively, the generated mobility failure information may comprise or represent, at least in part, if the respective handover from a (e.g. source or serving) cell A to another (e.g. target) cell B (preceding the mobility failure in cell B) is or was triggered by L3 or L1/2 inter-cell procedure.

Such a mobility failure information may enable the network performing and/or controlling the MRO, e.g. the network node of the second exemplary aspect, to determine whether the respective TEH/HWC associated with (e.g. being the reason that) the mobility failure (occurred) is or was caused by a misconfiguration of the L3 mobility parameters, or by a misconfiguration of the L1 inter-cell mobility, e.g. as represented by one or more of such parameters with which the respective UE of the first exemplary aspect is or was configured.

Further, the mobility failure information may comprise or represent, the time (e.g. time span or duration) that occurred between receiving the L1/2 HO command until the mobility failure (e.g. an RLF) has occurred. This time duration might be needed to enable the network node of the second exemplary aspect to distinguish between too late and too early L1/2 inter-cell mobility failure.

Further, the mobility failure information may comprise or represent, whether the respective cell change (e.g. handover) associated with the mobility failure occurred since the handover is or was triggered by L3 mobility procedure (BHO, CHO, DAPS HO) or a L1 mobility procedure. The mobility failure information may comprise or represent one or more PCIs of the respective cells.

In case ii.b), the respective UE of the first exemplary aspect may comprise a time (e.g. time span or duration) between receiving a L1/2 HO command (e.g. order) until a mobility failure (e.g. a RLF) occurs. This time may be beneficial to distinguish between TLH and TEH cases, e.g. too late and too early L1/2 inter-cell mobility failure.

According to an example embodiment of the first exemplary aspect, wherein in case type iii) is determined, the successful handover information comprises, at least in part:
iii.a) an indication whether a handover command is or was triggered by a L1/2- or a L3-mobility procedure; and
iii.b) an indication about a time duration between a reception of a reconfiguration information for L1/2 inter-cell mobility or the start of L1 beam measurement reporting until a reception of the handover command triggering L1/2 inter-cell mobility execution.

For this case iii.a), the successful handover information may comprise or represent, at least in part whether the handover is or was triggered by L3 mobility procedure or L1 inter-cell mobility.

Further, the successful handover information may comprise or represent the time (e.g. time span or duration) that occurred between the reception of a respective configuration of the target cells involved in L1/2 centric mobility until a reception of e.g. a MAC CE triggering an inter-cell change (handover).

Additionally or alternatively, the successful handover information may comprise or represent the time (e.g. time span or duration) that occurred from the time instant when the respective UE starts to report one or more L1 measurements for its serving cell and a target cell involved in L1/2 centric mobility until a reception of e.g. a MAC CE triggering the respective inter-cell change (handover).

The network, e.g. the network node of the second exemplary aspect may use such a successful handover information (or one or more pieces of successful handover information) e.g. to determine or detect too early preparation of one or more target cells that are prepared for L1/2 inter-cell mobility.

In case iii.b), the respective UE of the first exemplary aspect may store and provide, at least as a part of the successful handover information, a time duration from a time instant the respective UE receives a configuration of one or more target cells involved in L1/2 centric mobility until a MAC CE triggering the inter-cell change is received. Alternatively, the respective UE may store and provide, at least as a part of the successful handover information, a time duration from the time instant it starts to report one or more L1 measurements for the serving cell and one or more target cells involved in L1/2 centric mobility until the MAC CE triggering the inter-cell change is received.

According to an example embodiment of the first exemplary aspect, the mobility failure information is part of a radio link failure report message provided by the apparatus, and/or wherein the successful handover information is part of a successful handover report message.

According to an example embodiment of the first exemplary aspect, the method further comprises:
starting a timer, wherein the timer is started in response to receiving a handover command (e.g. a MAC CE; or a L1/2 HO Order), or wherein the timer is started upon reception of a reconfiguration information (e.g. a RRC Reconfiguration message), or wherein the timer is started upon providing of beam measurement information (e.g. one or more L1 beam measurements), and
stopping the timer, wherein the timer is stopped upon detecting of the mobility failure, or wherein the timer is stopped in response to receiving a handover command after the reception of the reconfiguration information.

In particular, in the type ii) and iii) as a determined type of mobility failure or in case of a detected successful handover, the generated mobility failure information or the successful handover information may comprise a certain duration as determined by a respective timer. This may allow the network (e.g. a network node of the second exemplary aspect) e.g. to too early preparation of one or more target cells that are prepared for L1/2 inter-cell mobility, and/or to distinguish between too late and too early L1/2 inter-cell mobility failure.

According to an example embodiment of the first exemplary aspect, wherein the mobility failure information or the successful handover information comprises a duration of the timer.

According to an example embodiment of the first exemplary aspect, wherein the respective apparatus performing and/or controlling the method of the first exemplary aspect is a user equipment, or a part of a user equipment.

A respective UE may include a wireless or mobile device, an apparatus with a radio interface to interact with a RAN (Radio Access Network), a smartphone, an in-vehicle apparatus, an IoT device, a M2M device, or else. Such UE or apparatus may comprise: at least one processor; and at least one memory including computer program code; wherein the at least one memory and the computer program code are configured to, with the at least one processor, cause the apparatus at least to perform certain operations, like e.g. RRC connection to the RAN. A UE is e.g. configured to generate a message (e.g. including a cell ID) to be transmitted via radio towards a RAN (e.g. to reach and communicate with a serving cell). A UE may generate and transmit and receive RRC messages containing one or more RRC PDUs (Packet Data Units).

The network node of the second exemplary aspect is provided with one or more pieces of mobility failure information and/or with one or more pieces of successful handover information. Such one or more pieces of mobility failure information and/or the one or more pieces of successful handover information may for instance stem from one or more UEs, e.g. representing apparatuses of the first exemplary aspect. The one or more pieces of mobility failure information and/or the one or more pieces of successful handover information may for instance be received from one or more apparatuses, e.g. representing apparatuses of the first exemplary aspect. The one or more pieces of mobility failure information and/or the one or more pieces of successful handover information may for instance be received directly from such one or more apparatus, e.g. representing apparatuses of the first exemplary aspect, or via an entity of the mobile communication network that is different from the apparatus (e.g. network node) of the second exemplary aspect. The one or more pieces of mobility failure information and/or the one or more pieces of successful handover information may for instance be obtained, e.g. by retrieving the one or more pieces of mobility failure information and/or the one or more pieces of successful handover information from a memory. For instance, the one or more UEs, e.g. representing apparatuses of the first exemplary aspect may provide such one or more pieces of mobility failure information and/or the one or more pieces of successful handover information so that the one or more pieces of mobility failure information and/or the one or more pieces of successful handover information are stored in the memory. Then, the network node of the second exemplary aspect may retrieve the one or more pieces of mobility failure information and/or the one or more pieces of successful handover information so that then the network node of the second exemplary aspect is provided with the one or more pieces of mobility failure information and/or the one or more pieces of successful handover information.

Based, at least in part, on the one or more pieces of mobility failure information and/or the one or more pieces of successful handover information, it is determined whether the root cause associated with at least one of a respective mobility failure information and a respective successful handover information is related to or caused by a misconfiguration of a L1/2- or L3 mobility procedure. This may be allowed since a respective mobility failure information of the one or more pieces of mobility failure information is generated (on part of a respective UE of the first exemplary aspect) to comprise or represent information related to a type of mobility failure, or a respective successful handover information of the one or more pieces of successful handover information comprises information representing if one or more undesired events of a handover procedure may have been caused by misconfigured one or more parameters controlling a mobility procedure of the respective UE. The network performing and/or controlling the method according to the second exemplary aspect (also referred to as the network node of the second exemplary aspect) is enabled to determine whether the cause of the respective mobility failure of a respective mobility failure information is related to a misconfiguration of a L1/2- or L3 mobility procedure.

If the cause is related to a misconfiguration of a L1/2 mobility procedure, the network node of the second exemplary aspect determines adjusted (e.g. optimized) one or more parameters to be used for an upcoming L1/2- or L3 (e.g. inter-cell) mobility (e.g. procedures) of the respective UE of the first exemplary aspect. The one or more parameters may for instance be adjusted (e.g. optimized) in the regard that the mobility failure or one or more too early preparation events of a candidate target cell for a handover that occurred is prevented, or likely to be prevented if a same situation of a mobility procedure occurs in the network in future. The one or more parameters may be adjusted (e.g. optimized) specifically for a respective UE (e.g. according to the first exemplary aspect) from which the respective mobility failure information is received or obtained. In addition or in the alternative, such one or more parameters may be adjusted (e.g. optimized) for one or more further UEs (e.g. according to the first exemplary aspect) from which the respective mobility failure information based on which, at least in part, the adjusted one or more parameters are determined, do not stem. Thus, the one or more adjusted parameters may be provided to a respective UE so that a mobility procedure of the respective UE is controlled by the one or more adjusted parameters. The respective UE to which the one or more adjusted parameters are provided may be different from one or more UEs that provided (e.g. sent) the mobility failure information that were used to determine the one or more adjusted parameters.

This may allow that a respective network node of the second exemplary aspect e.g. hosting a SON/MRO instance controlling the root cause analysis and the processing of a mobility KPIs (e.g., network node controlling source cell A, e.g. representing a respective network node of the second exemplary aspect; or near real-time RIC in case of O-RAN, e.g. representing a respective network node of the second exemplary aspect) is provided with the information (e.g. the mobility failure information to perform and/or control one or more following:
A) determine whether a cause of the mobility failure or of e.g. one or more too early preparation events of a candidate target cell for a handover relates to the misconfiguration of:
   1) one or more parameters controlling L3 handover procedures (BHO, CHO or DAPS), or
   2) the parameters controlling L1/2 inter-cell mobility; and
B) adjust (e.g. optimize) one or more parameters of L1/2 inter-cell mobility, if those are found to be guilty of mobility failures.

According to an example embodiment of the second exemplary aspect, the mobility failure occurred in association with an inter-cell handover procedure.

For instance, it may be determined that the root cause associated with at least one of the respective mobility failure information and the respective successful handover information is related to a misconfiguration of a L1/2 mobility procedure. Then, it may be assumed that the respective mobility failure of a respective piece of the one or more pieces of mobility failure information occurred in association with an inter-cell handover procedure. Additionally or alternatively, it may be assumed that a respective undesired event that occurred in association with a successful handover, are related to one or more parameters controlling L1/2 mobility.

For instance, the respective mobility failure of a respective piece of the one or more pieces of mobility failure information occurred due to such an inter-cell handover procedure. This may comprise the respective mobility failure occurred prior to a handover being performed and/or controlled, during a respective handover being performed and/or controlled, or after a respective handover was performed and/or controlled.

According to an example embodiment of the second exemplary aspect, the misconfiguration is related to:
a misconfiguration of one or more parameters controlling L3 handover, or
a misconfiguration of one or more parameters controlling L1/2 inter-cell mobility.

The misconfiguration of the one or more parameters may be related to one or more parameters that are used for controlling L3 handover of a respective UE (e.g. according to the first exemplary aspect). Alternatively, the misconfiguration of the one or more parameters may be related to one or more parameters that are used for controlling L1/2 inter-cell mobility of a respective UE (e.g. according to the first exemplary aspect).

For instance, the network node of the second exemplary aspect may utilize if the misconfiguration of one or more parameters is or was related to a controlling L3 handover, or a controlling L1/2 inter-cell mobility e.g. to determine if the respective mobility failure was caused by a too long reporting periodicity, or for instance if the configured period is long, to name but a few non-limiting example. Then, MRO can be performed and/or controlled e.g. by the network node of the second exemplary aspect adjusting (e.g. optimizing) e.g. a reporting periodicity to be performed by a respective UE (e.g. according to the first exemplary aspect) to occur more often or frequent, to name but one non-limiting example.

The network node of the second exemplary aspect may use the knowledge of if the misconfiguration of one or more parameters is or was related to a controlling L3 handover, or a controlling L1/2 inter-cell mobility e.g. to determine or detect e.g. too early preparation of one or more target cells that are prepared for L1/2 inter-cell mobility. The one or more parameters may be adjusted (e.g. optimized) accordingly to prevent such a too early preparation of one or more target cells that are prepared for L1/2 inter-cell mobility from occurring in future same or similar scenarios, e.g. in the mobile communication network.

According to an example embodiment of the second exemplary aspect, the mobility failure occurred in association with a baseline handover (BHO), BHO failure, conditional handover (CHO), CHO failure, or a dual active protocol stack (DAPS) handover or DAPS failure.

For instance, if the mobility failure occurred due to a BHO, CFO or DAPS HO failure, the network node of the second exemplary aspect e.g. controlling a cell may inform another network node (e.g. representing another instance of a network node of the second exemplary aspect) controlling another cell, e.g. by forwarding a respective mobility failure information of the one or more pieces of mobility failure information to the other network node. Additionally or alternatively, the network node may inform the other network node (e.g. in a handover report) whether the cell change that led to the respective mobility failure from the cell controlled by the network node to the cell controlled by the other network node is or was triggered by L3 mobility. L3 mobility procedure may be a root for a respective mobility failure occurring due to a BHO, CFO or DAPS HO failure.

According to an example embodiment of the second exemplary aspect, the one or more adjusted parameters are determined in response to the cause being a misconfiguration of one or more parameters controlling L1/2 inter-cell mobility.

For instance, if the mobility failure occurred due to a TLH failure, or after a successful handover, the network node of the second exemplary aspect e.g. controlling a cell may inform another network node (e.g. representing another instance of a network node of the second exemplary aspect) controlling another cell, e.g. by forwarding a respective mobility failure information of the one or more pieces of mobility failure information and/or by forwarding a respective successful handover information of the one or more pieces of successful handover information to the other network node. Additionally or alternatively, the network node may inform the other network node (e.g. in a handover report) whether the cell change that led to the respective mobility failure from the cell controlled by the network node to the cell controlled by the other network node is or was triggered by L1/2 mobility.

According to an example embodiment of the second exemplary aspect, the one or more adjusted parameters are determined such that a controlling of L1/2 inter-cell mobility is optimized.

For instance, a same or similar mobility failure and/or one or more undesired events should be avoided to be occurring in future same, or similar situations (based on the obtained or received information). This may be allowed due to determining the one or more adjusted (e.g. optimized) parameters that control L1/2 inter-cell mobility on part of a respective UE (e.g. according to the first exemplary aspect). It will be understood that a respective UE is then configured accordingly, e.g. by providing a respective configuration comprising the one or more adjusted (e.g. optimized) parameters to the respective UE, and the respective UE may then active the configuration.

According to an example embodiment of the second exemplary aspect, the one or more pieces of mobility failure information are part of one or more radio link failure report messages, and/or wherein the one or more pieces of successful handover information are part of one or more successful handover report messages. A respective successful handover report message or a respective radio link failure report message may be received or obtained by the network node of the second exemplary aspect.

According to an example embodiment of the second exemplary aspect, the apparatus performing and/or controlling the method of the second exemplary aspect is a network node providing a serving cell to at least one user equipment, an Access and Mobility Management Function, AMF, element, or a centralized unit, or a part thereof.

A RAN (Radio Access Network) node or network node like e.g. a gNB, base station, gNB CU or gNB DU or parts thereof may be implemented using e.g. an apparatus with at least one processor and/or at least one memory (with computer-readable instructions (computer program)) configured to support and/or provision and/or processing of CU and/or DU related functionality and/or features, and/or at least one protocol (sub-)layer of a RAN (Radio Access Network), e.g. layer 2 and/or layer 3. The mobile communication network, as used herein, may be a RAN.

A gNB Central Unit (gNB-CU) comprises e.g. a logical node hosting e.g. RRC, SDAP and PDCP protocols of the gNB or RRC and PDCP protocols of the en-gNB that controls the operation of one or more gNB-DUs. The gNB-CU terminates the F1 interface connected with the gNB-DU.

A gNB Distributed Unit (gNB-DU) comprises e.g. a logical node hosting e.g. RLC, MAC and PHY layers of the gNB or en-gNB, and its operation is partly controlled by the gNB-CU. One gNB-DU supports one or multiple cells. One cell is supported by only one gNB-DU. The gNB-DU terminates the F1 interface connected with the gNB-CU.

The gNB CU and gNB DU parts may e.g. be co-located or physically separated. gNB DU may even be split further, e.g. into two parts, e.g. one including processing equipment and one including an antenna. A Central Unit (CU) may also be called BBU/REC/RCC/C-RAN/V-RAN, O-RAN, or part thereof. A Distributed Unit (DU) may also be called RRH/RRU/RE/RU, or part thereof.

gNB-DU supports one or multiple cells, and could thus serve as e.g. a serving cell for user equipment (UE).

According to an example embodiment of the second exemplary aspect, the method further comprising:
forwarding the one or more pieces of mobility failure information and/or the one or more successful handover information to one or more network entities.

The one or more pieces of mobility failure information and/or the one or more successful handover information may for instance be forwarded to one or more further/other network nodes (e.g.

respectively representing a network node of the second exemplary aspect) e.g. hosting a distributed unit, one or more further other network nodes hosting a centralized unit, one or more AMF elements, or a combination thereof.

For instance, a respective network node of the second exemplary aspect that is provided with the one or more pieces of mobility failure information and/or the one or more successful handover information may host a centralized unit. This network node may forward the one or more pieces of mobility failure information and/or the one or more successful handover information to another network node (e.g. according to the second exemplary aspect) also hosting a centralized unit. The other network node also hosting a centralized unit may then again forward the one or more pieces of mobility failure information and/or the one or more successful handover information to a third network node (e.g. according to the second exemplary aspect) hosting a decentralized unit, for instance. In the case of a respective successful handover information, the respective forwarded successful handover information may be comprised by, or be a part of an Access and Mobility Indication.

The respective network node of the second exemplary aspect that is provided with and/or forwarded with a respective mobility failure information or with a respective successful handover information and/or may host a centralized unit. Then, the respective mobility failure information and/or the respective successful handover information may be forwarded to another network node (e.g. according to the second exemplary aspect) also hosting a centralized unit.

According to an example embodiment of the second exemplary aspect, the method further comprising:
providing the determined adjusted one or more parameters.

The determined adjusted one or more parameters may be provided, e.g. by sending or forwarding the determined adjusted one or more parameters. The determined adjusted one or more parameters may be sent to a respective UE (e.g. according to the first exemplary aspect) or to one or more UE (e.g. according to the first exemplary aspect). In addition or in the alternative, the determined adjusted one or more parameters may be forwarded to another network node (e.g. according to the second exemplary aspect) so that the other network node may sent the determined adjusted one or more parameters may be sent to a respective UE (e.g. according to the first exemplary aspect) or to one or more UE (e.g. according to the first exemplary aspect). This may allow to configure a respective UE (e.g.

according to the first exemplary aspect) or one or more UE (e.g. according to the first exemplary aspect) with the adjusted one or more parameters. This may allow to perform and/or control MRO, in particular in SON.

The features and example embodiments described above may equally pertain to the different aspects.

It is to be understood that the presentation in this section is merely by way of examples and non-limiting.

Other features will become apparent from the following detailed description considered in conjunction with the accompanying drawings. It is to be understood, however, that the drawings are designed solely for purposes of illustration and not as a definition of the limits, for which reference should be made to the appended claims. It should be further understood that the drawings are not drawn to scale and that they are merely intended to conceptually illustrate the structures and procedures described herein.

### BRIEF DESCRIPTION OF THE DRAWINGS

In the figures show:

FIG. 1 a schematic diagram of a system according to an exemplary embodiment;

FIG. 2 a flowchart showing an example embodiment of a method according to the first exemplary aspect;

FIG. 3 a flowchart showing an example embodiment of a method according to the second exemplary aspect;

FIG. 4 example transmissions and example actions between a UE according to the first exemplary aspect and one or more network nodes according to the second exemplary aspect;

FIG. 5 example transmissions and example actions between a UE according to the first exemplary aspect and one or more network nodes according to the second exemplary aspect;

FIG. 6 example transmissions and example actions between a UE according to the first exemplary aspect and one or more network nodes according to the second exemplary aspect; and

FIG. 7 a schematic block diagram of an apparatus according to an example embodiment of the first or second exemplary aspect.

### DETAILED DESCRIPTION OF SOME EXEMPLARY EMBODIMENTS

The following description serves to deepen the understanding and shall be understood to complement and be read together with the description as provided in the above summary section of this specification.

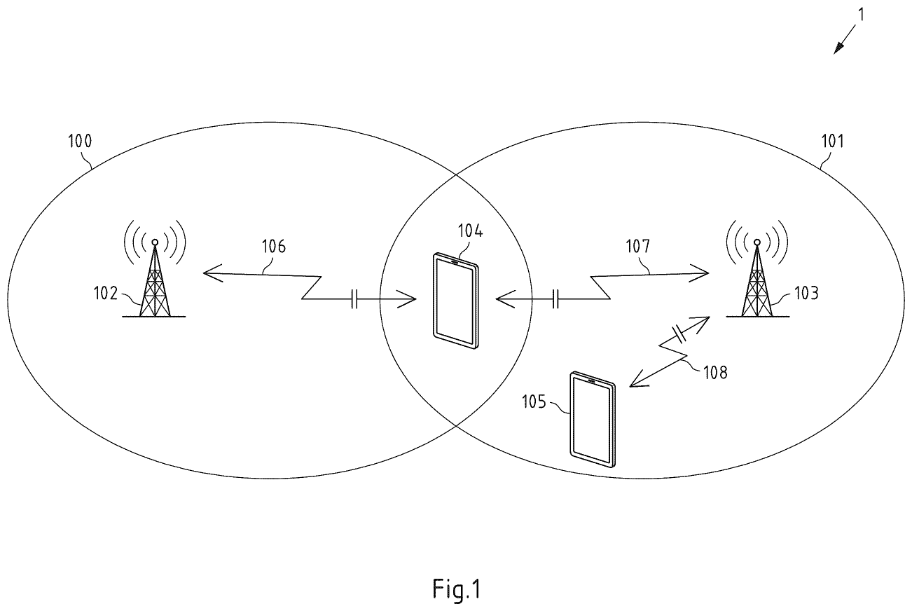

FIG. 1 shows a schematic diagram of a system 1 according to an example embodiment, showing a UE 104 in an overlapping cell region.

More specifically, FIG. 1 shows a first cell 100 of a first network node 102 and a second cell 101 of a second network node 103. Additionally, FIG. 1 shows a first UE 104 and a second UE 105.

The first and second UE 104, 105 may be represented by a respective UE of the first exemplary aspect. The first and second network node 102, 103 may be represented by a respective network of the second exemplary aspect.

The second UE 105 is located in the second cell 101. It is connected to the second cell 101 of the second base station 103 via a radio link 108.

UE 105 may have established a radio link 108 of the second network node 103. UE 104 may have established a radio link 107 to the second network node 103, and/or may have established a radio link 106 to the first network node 102. While UE 105 may have performed and/or controlled a successful handover from cell 100 to cell 101, UE 104 may be configured with cell 100 as a target cell for a potential handover from cell 101 to cell 100.

The two parallel lines drawn and interrupting the illustrated double arrows showing the radio links, e.g. at radio link 108 may indicate that a mobility failure, here a radio link failure can or has occurred. In case of UE 105, the mobility failure may have been occurred prior to a handover of the UE 105 from cell 101 to cell 100. In case of UE 104, if the radio link 107 is subject to a mobility failure, and UE 104 is to be handed over from cell 100 to cell 101, the mobility failure may have been occurred during, at, or in association with a handover. Also, radio link 106 may be subject to a mobility failure.

Dependent upon the mobility failure that may occur, for instance, network node 102 and/or network node 103 may perform and/or control MRO, e.g. by determining one or more adjusted parameters for an upcoming L1/2- or L3 mobility procedure.

In general, there may be the following mobility failure types considered:

3GPP Technical Specification (TS) 32.425, section 4.3.1.3.3, 3GPP TS 36.300, section 22.4.2.2 and 3GPP TS 38.300, section 15.5.2.2.2 may distinguish between the following three types of mobility failures that might be considered for MRO as proposed by example embodiments of all exemplary aspects:
1. Too-late handover (TLH): A respective mobility failure (e.g. an RLF) occurs after the UE has stayed for a long time period in cell A (e.g. cell 101 and the UE (e.g. UE 104, 105) attempts to re-establish the radio link connection in a different cell B (e.g. cell 100).
2. Too-early handover (TEH): A respective mobility failure (e.g. an RLF) occurs (e.g. shortly) after a successful handover from a source cell A to a target cell B and the UE attempts to re-establish the radio link connection in the source cell A.
3. Handover to wrong cell (HWC): A respective mobility failure (e.g. an RLF) occurs (e.g. shortly) after a successful handover from a source cell to A to target cell B and the UE attempts to re-establish the radio link connection in a cell C other than the source cell A and the target cell B.

Currently, MRO is dealing with an optimization of the parameters controlling L3 mobility procedures. Example embodiments of all exemplary aspects provide a solution that may allow to address such an optimization of parameters controlling L1/2 inter-cell mobility, as disclosed in this specification.

With regard to L3 mobility procedures, New Radio Rel. 15 has specified a baseline handover (BHO) procedure which is similar to that defined for LTE system (see e.g. 3GPP TS 36.300). In NR and LTE Rel. 16, new handover procedures are specified to improve mobility robustness or/and mobility interruption time:
Conditional handover (CHO) (see 3GPP TS 38.300): CHO has been introduced to improve mainly mobility robustness, i.e., to reduce connection failures. In BHO of NR Rel. 15, the respective UE will (e.g. immediately) access a target cell to complete the handover. Instead, in CHO, the respective UE will (e.g. only) access the target cell once an additional CHO execution condition expires (i.e. the HO preparation and execution phases are decoupled). The condition is configured, e.g. by a respective network node (e.g. the source node in HO Command). This may allow that the HO command can be sent very early, i.e., when the UE is still safe in the source cell, without risking the access in the target cell and the stability of its radio link, which in turn provides robustness.
Dual Active Protocol Stack (DAPS) handover (see 3GPP TS 38.300): DAPS HO has been introduced in Rel. 16 to achieve close to 0 ms interruption time in downlink (DL) and/or uplink (UL). Herein, a respective network node e.g. providing the source cell and another respective network node providing the target cell may have full L2 protocol stack e.g. with own security key for ciphering and deciphering of the Packet Data Convergence Protocol (PDCP) Service Data Units (SDUs). To avoid a hard handover causing service interruption, the respective UE may establish a new radio link with respect to the target cell before detaching the radio link of or to the source cell. That is for some time before releasing the source cell, the UE would be exchanging data with both source and target nodes.

With regard to L1/2 Inter-Cell Mobility, in Rel. 17, L1/2 inter-cell mobility has been discussed under feMIMO Rel. 17 WI. In contrast to L3 mobility procedures where the handovers are decided by RRC layer, L1/2 inter-cell mobility is performed by the MAC layer terminated in a respective Distributed Unit (DU), e.g. hosted by a respective network node. L1/2 centric inter-cell mobility for intra- and inter-DU scenarios has not yet been specified.

L1/2 inter-cell mobility may comprise the following steps summarized in the following:
The L1/2 inter-cell mobility may consist of two phases, namely preparation phase of one or more potential target cells for handover based on e.g. L3 measurements (denoted by Phase 1) and a handover execution phase with L1/2 triggered cell change (denoted by Phase 2). The execution of the handover may be initiated by the network (e.g. a respective network node of the second exemplary aspect) e.g. by sending a MAC Control Element (MAC CE) to the respective UE.
Thus, a serving cell or Centralized Unit (CU) of the serving cell hosting the RRC layer may configure the respective UE e.g. to perform L3 measurements for identifying a potential set of target cells for handovers.
Upon receiving a measurement report identifying one or more potential target cells for handover, the respective CU of the serving cell may request the preparation of these target cells and may receive either from a serving DUs or neighboring CUs, which are serving the envisaged target cells, the respective UE configuration(s) (e.g. comprising protocol layer configuration for e.g. PHY/MAC/RLC, C-RNTI, random access parameters, system information, or a combination thereof, to name but a few non-limiting examples) that are provided to the respective UE, i.e., similar to CHO preparation. The respective UE may execute one of these configurations once it gets the MAC CE triggering the cell change to a specific target cell.
The serving cell (e.g. the respective network node providing the serving cell) may configure the respective UE to report L1 signal strength (L1-RSRP) or quality (L1-SINR) beam measurement(s) for the serving cell and the configured prepared target cells to the serving cell (not the CU). This report may be done using L1/L2 signaling.
Upon determining that there is a target cell having a better radio link beam measurement than the serving cell, e.g., L1-RSRP of target cell>L1-RSRP of serving+Off for e.g. Time-to-Trigger (TTT) time, the serving cell may send a MAC Control Element (MAC CE) or a L1 order to trigger the cell change to the target cell, i.e., unlike L3 mobility where an RRC Reconfiguration message is sent for triggering the cell change in case of baseline handover or DAPS HO.
It may not be decided whether the condition for triggering the cell change will be specified or left for network implementation.
When the respective UE receives the MAC CE for performing and/or controlling the cell change (e.g. HO) to a specific target cell, the respective UE may apply its corresponding (e.g. stored) configuration and connects to the target cell by performing random access, if needed.
The respective network node (e.g. acting as a gNB CU) may not be aware of the handover triggered by the cell. A respective network node (e.g. acting as a gNB-DU) controlling the L1/L2 of the source and target cell may be aware of the moment of the handover.

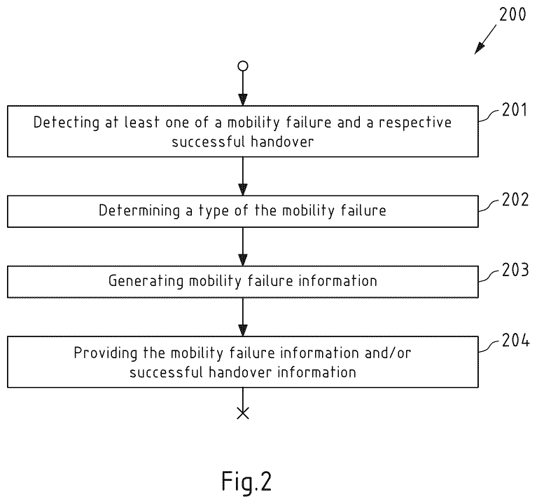

FIG. 2 is a flowchart 200 showing an example embodiment of a method according to the first exemplary aspect. This flowchart 200 may for instance be performed by a UE, e.g. UE 104 or UE 105 of FIG. 1.

In a first step 201, at least one of a mobility failure and a successful handover is detected. For instance, a radio link established between the UE and a network node (e.g. network node 102, 103 of FIG. 1) has a failure. Such a mobility failure occurred in association with, or at a handover of the respective UE performing a cell change, e.g. from cell 101 to 100 of FIG. 1, or vice versa.

In a second step 202, a type of the mobility failure (detected in step 201) is determined. The type of the mobility failure is determined in response to the detected mobility failure. It may for instance be determined if the mobility failure occurs in a (e.g. current) serving cell of the respective UE with no (L1 or L3) cell change order (handover command) received by the UE. It may for instance be determined if the mobility failure occurs (e.g. shortly) after receiving a (L1 or L3) cell change order (handover command). It may for instance be determined if the mobility failure occurs after a successful handover was performed.

In a third step 203, mobility failure information is generated. The mobility failure information may be generated such that information may allow an optimization of one or more parameters controlling L1/2 inter-cell mobility can be achieved. The mobility failure information may be generated, at least in part, based on the determined type of the mobility failure. In case of a detected successful handover in step 201, information that may allow an optimization of one or more parameters controlling L1/2 inter-cell mobility after the successful handover may be stored, e.g. in a memory comprised by or connectable to the respective UE.

In a fourth step 204, the mobility failure information (e.g. generated in step 203) is provided, e.g. by outputting or sending the generated mobility failure information to a network node (e.g. network node 102, 103 of FIG. 1, e.g. a network node currently serving the respective UE). In case of a detected successful handover in step 201, successful handover information is provided, wherein the successful handover information comprises or represents, at least in part, the information that may allow an optimization of one or more parameters controlling L1/2 inter-cell mobility after the successful handover. For this, the respective UE may retrieve the information from the memory so that the successful handover information can comprise such information.

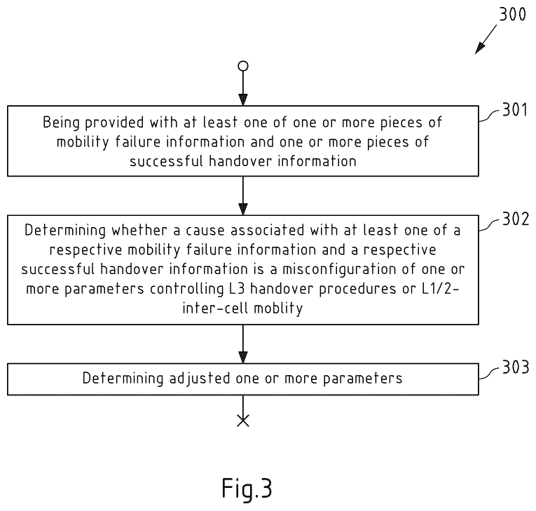

FIG. 3 is a flowchart 300 showing an example embodiment of a method according to the second exemplary aspect. This flowchart 300 may for instance be performed by a network node, e.g. network node 102, 103 of FIG. 1.

In a first step 301, the network node is provided with one or more pieces of mobility failure information. A respective mobility failure information of the one or more pieces of mobility failure information is indicative of one or more parameters associated with a type of a mobility failure. The network node may in addition or in the alternative be provided with one or more pieces of successful handover information.

The one or more pieces of mobility failure information and/or the one or more pieces of successful handover information may be received from one or more UEs, e.g. one or more of the UEs 104 or 105 of FIG. 1. The one or more pieces of mobility failure information and/or the one or more pieces of successful handover information may be obtained, e.g. by retrieving the one or more pieces of mobility failure information and/or the one or more pieces of successful handover information, e.g. from a storage or memory comprised by the respective network node, or connectable to the respective network node.

In a second step 302, it is determined, by the respective network node, whether a cause of a respective mobility failure of a respective mobility failure information is related to or is caused by or is a misconfiguration (e.g. of one or more parameters) of a L1/2- or L3 mobility procedure, e.g. L1/2 inter-cell mobility or L3 handover procedure. In addition or in the alternative, it may be determined, by the respective network node, whether a cause associated with a successful handover information is a misconfiguration of (e.g. one or more parameters) controlling L3 handover procedures or L1/2 inter-cell mobility.

In a third step 303, adjusted one or more parameters to be used for an upcoming L1/2- or L3 mobility procedure are determined. The adjusted one or more parameters may be determined dependent upon whether the determined cause is a misconfiguration controlling L3 handover or L1/2 inter-cell mobility. Then, the adjusted one or more parameters may be provided, e.g. to one or more UEs (e.g. one or more of the UEs 104 or 105 of FIG. 1) so that the respective UEs can be configured with the adjusted one or more parameters for future L1/2, or L3 mobility procedures.

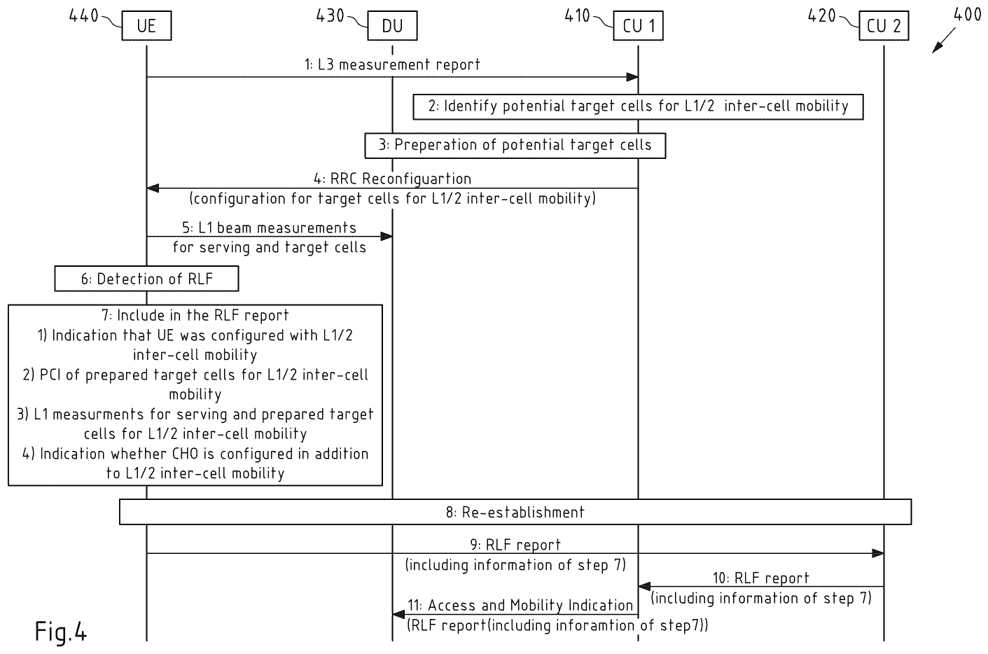

FIG. 4 shows example transmissions and example actions between a UE 440 according to the first exemplary aspect, a first CU 410, a second CU 420 and a DU 430 according to the second exemplary aspect. The step and actions shown in chart 400 will now be described.

In Step 1, the UE 440 provides a L3 measurement report of the first CU 410. Upon reception of the L3 measurement report, the first CU 410 identifies in a step 2 one or more potential target cells for L1/2 inter-cell mobility for the UE 440. The first CU 410 communicates with the DU 430 to prepare the one or more potential target cells in a step 3. A RRC Reconfiguration (e.g. message) configuring the UE 440 for or with the one or more potential target cells for its L1/2 inter-cell mobility is provided to the UE 440 from the first CU 410 in a step 4. The UE 440 may then perform and/or control L1 beam measurements both for the serving cell and for the one or more target cells configured in step 5.

In a step 6, the UE 440 detects a mobility failure, here a radio link failure. The UE 440 determines a type of the mobility failure to allow the UE 440 in a step 7 to generate mobility failure information, here a respective radio link failure report comprising the generated mobility failure information. The mobility failure information may include or comprise, among other things, an indication that the UE 440 was configured with L1/2 inter-cell mobility, PCI(s) of the prepared (e.g. and configured) target cells for L1/2 inter-cell mobility, L1 measurements for serving cell and the one or more prepared target cells for L1/2 inter-cell mobility, an indication whether CHO is configured in addition to L1/2 inter-cell mobility, or a combination thereof.

In a step 8, due to the occurred mobility failure associated with a handover, re-establishment of radio links of the UE 440 takes place.

In a step 9, the UE 440 provides the generated mobility failure information in the form of or comprised by a radio link failure report. Thus, the radio link failure report comprises the information of step 7. The mobility failure information is provided, by sending the mobility failure information from the UE 440 to the second CU 420 e.g. hosting and/or controlling the serving cell for the UE 440. Upon or after reception of the mobility failure information, the second CU 420 forwards the mobility failure information in the form of or comprised by a radio link failure report (including the information of step 7) to the first CU 410. In a step 11, the first CU 410 forwards sends an Access and Mobility Indication having the mobility failure information in the form of or comprised by a radio link failure report to the DU 430.

FIG. 4 illustrates a case where the mobility failure occurred due to a TLH case. Upon detection of the mobility failure in step 6, the UE 440 generates the mobility failure information such that it comprises information necessary that the DU 430, the CU 410 and/or the CU 420 can perform and/or control MRO, e.g. by determining one or more adjusted parameters to be used (e.g. by the UE 440) for optimized L1/2 inter-cell mobility.

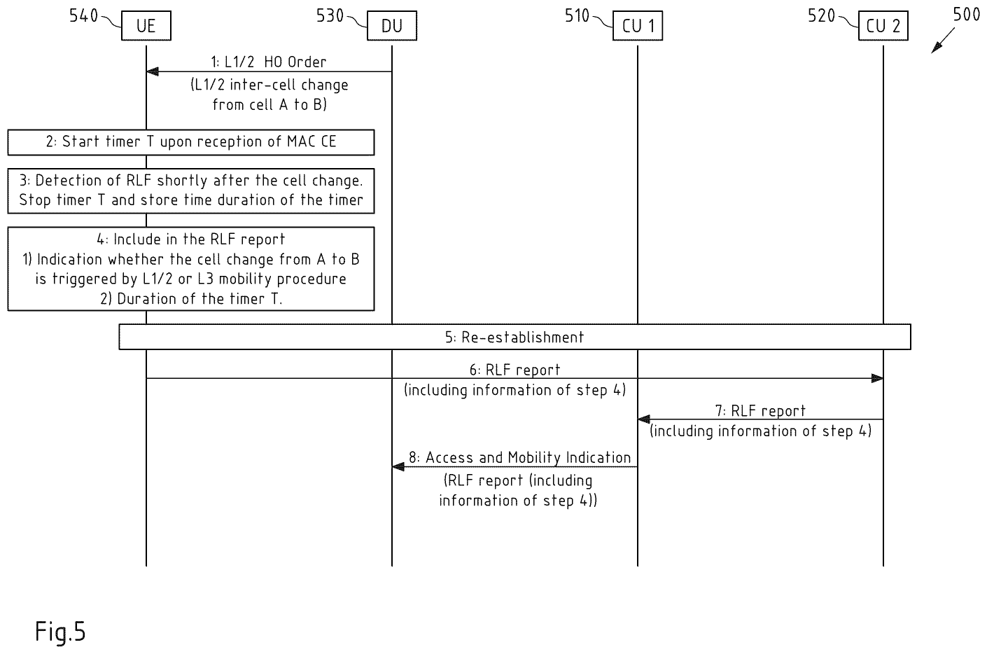

FIG. 5 shows example transmissions and example actions between a UE 540 according to the first exemplary aspect, a first CU 510, a second CU 520 and a DU 530 according to the second exemplary aspect. The step and actions shown in chart 500 will now be described.

In a step 1, the UE 540 receives from the DU 530 a L1/2 HO Order triggering that the UE 540 performs and/or controls a handover, here a L1/2 inter-cell change from cell A to B.

In a step 2, the UE 540 starts a timer T upon reception of MAC CE triggering the L1/2 inter-cell change.

In a step 3, the UE 540 detects a mobility failure, here a radio link failure. The UE 540 determines a type of the mobility failure to allow the UE 540 in a step 4 to generate mobility failure information, here a respective radio link failure report comprising the generated mobility failure information. The mobility failure information may include or comprise, among other things, an indication whether the cell change from the cell A to the cell B is triggered by L1/2 or L3 mobility procedure, and a duration of the timer T. In a step 5, due to the occurred mobility failure associated with a handover, re-establishment of radio link of the UE 540 takes place. In a step 6, the UE 540 provides the generated mobility failure information in the form of or comprised by a radio link failure report. Thus, the radio link failure report comprises the information of step 4. The mobility failure information is provided, by sending the mobility failure information from the UE 540 to the second CU 520. Upon or after reception of the mobility failure information, the second CU 520 forwards the mobility failure information in the form of or comprised by a radio link failure report (including the information of step 4) to the first CU 510 in a step 7. In a step 8, the first CU 410 forwards sends an Access and Mobility Indication having the mobility failure information in the form of or comprised by a radio link failure report to the DU 430.

FIG. 5 illustrates a case where the mobility failure occurred due to a mobility failure associated with or happening at a TEH or HWC HO case. Upon detection of the mobility failure in step 3, the UE 540 generates the mobility failure information such that it comprises information necessary that the DU 530, the CU 510 and/or the CU 520 can perform and/or control MRO, e.g. by determining one or more adjusted parameters to be used (e.g. by the UE 540) for optimized L1/2 inter-cell mobility.

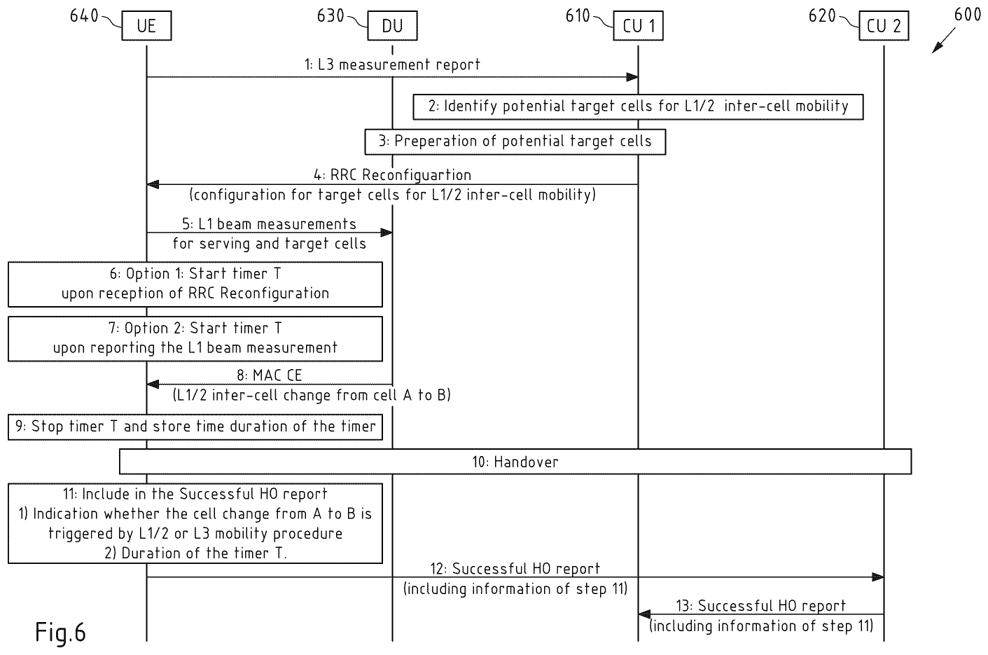

FIG. 6 shows example transmissions and example actions between a UE 640 according to the first exemplary aspect, a first CU 610, a second CU 620 and a DU 630 according to the second exemplary aspect. The step and actions shown in chart 600 will now be described.

The steps 1 to 5 are the same as described above with regard to FIG. 4.

In a step 6, upon reception of the RRC Reconfiguration, the UE 640 may, as a first option, start a timer T. In a step 7, as a second option which may be an alternative to step 6, the UE 640 may start a/the timer T upon reporting of the L1 beam measurement(s) provided by the UE 640 to the DU 630 in step 5.

In a step 8, a MAC CE triggering the L1/2 inter-cell change from the cell A to the cell B is received by the UE 640. The MAC CE was sent by the DU 630. In a step 9, the UE 640 stops the timer T and stores the time duration gathered by the timer T.

In a step 10, the handover procedure is performed and/or controlled.

The UE 640 determines in step 11 for the successful handover information (e.g. the successful handover report) one or more parameters associated with the respective successful handover that enable a network (e.g. the CU 610, the CU 620, and/or the DU 630) to determine whether a root cause in association with the handover of step 10, e.g. happening after the handover of step 10) is a misconfiguration of the one or more parameters controlling L3 handover procedures or L1/2 inter-cell mobility. The successful handover report may include or comprise, among other things, an indication whether the cell change from a cell A to the cell B (of the handover of step 10) is or was triggered by L1/2 or L3 mobility procedure, and a duration of the timer T stored in step 9.

In a step 12, the UE 640 provides the successful handover report. The successful handover report comprises the information of step 11. The successful handover report is provided, by sending the successful handover report from the UE 640 to the second CU 620. Upon or after reception of the successful handover report, the second CU 620 forwards the successful handover report (including the information of step 11) to the first CU 610 in a step 13.

FIG. 6 illustrates a case where one or more undesired events (e.g. at least one of a TEH and HWC) occur in association with (e.g. before, during or after) a successful handover a successful handover. The UE 640 generates the successful handover report such that it comprises information necessary that the CU 620, or the CU 610 can perform and/or control MRO, e.g. by determining one or more adjusted parameters to be used (e.g. by the UE 640) for optimized L1/2 inter-cell mobility.

As described in summary section, example embodiments of all exemplary aspects may allow MRO KPI counters for L1/2 inter-cell mobility to be created (e.g. generated by a respective UE of the first exemplary aspect) during root cause analysis based on the generated mobility failure information and/or the successful handover information (e.g. in the following also referred to as newly introduced information). Such mobility failure information and/or the successful handover information may be provided with the radio link failure report or successful handover report (e.g. in the form of respective messages), which may be forwarded within the network by means of XnAP (e.g. Failure Indication msg) and/or F1AP (e.g. Access and Mobility Indication messages), e.g. to a respective network node hosting the responsible MRO entity. Those counters can be, for instance, delivered to a more centrally located master MRO instance which finally decides about the corrective countermeasures (e.g. re-adjustments of the L1/2 parameters that is triggering MAC CE by determining adjusted one or more parameters) in case of standard 3GPP architecture.

The definition of such KPIs may impact a performance management in SA5, e.g. 3GPP 28.552 (PM), 28.554 (PM).

In case of the O-RAN architecture, the root cause analysis may be carried out by an MRO client (e.g. represented by a network node of the second exemplary aspect) located in the RT-RIC. The RT-RIC may create (e.g. generated) the above defined KPIs (e.g. the generated one or more pieces of mobility failure information and/or the one or more pieces of successful handover information). The counters of the KPIs may be provided (e.g. reported) to a master MRO unit located in the non-RT RIC, where the corrective parameter adjustments are determined, e.g. by determining the adjusted one or more parameters. The impacted interfaces and standard documents are listed here:
O-RAN Near-Real-time RAN Intelligent Controller, E2 Application Protocol
O-RAN Near-Real-time RAN Intelligent Controller E2 Service Model
O-RAN Near-Real-time RAN Intelligent Controller E2 Service Model (E2SM), RAN Function Network Interface (NI)
O-RAN Near-Real-time RAN Intelligent Controller E2 Service Model (E2SM) KPM
O-RAN 01 Interface specification for O-DU 1.0
O-RAN 01 Interface specification for O-DU 1.0—YANG models
O-RAN 01 Interface specification for O-DU 1.0—Configuration tables
O-RAN A1 interface: Type Definitions
O-RAN A1 interface: General Aspects and Principles
O-RAN A1 interface: Application Protocol

This may allow to enable the network to identify whether a respective mobility problem/failure and/or one or more a root cause associated with a successful handover (e.g. as represented by a respective successful handover information) is/are caused by a misconfiguration of the L3 mobility parameters that are controlled by RRC (e.g., baseline HO, CHO and DAPS HO) or a misconfiguration of the L1 (or L1/L2) inter-cell mobility parameters that are e.g. controlled by the DU. This may further allow to provide the network with (e.g. all the necessary) information to optimize the parameters controlling L1/2 inter-cell mobility change.

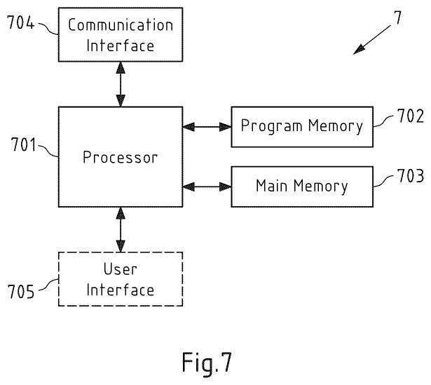

It will be referred to FIG. 7 now. FIG. 7 shows a schematic block diagram of an apparatus 7 according to an example embodiment of the first or second exemplary aspect. The apparatus 7 may be a UE, a DU, a CU and/or a network node, e.g. comprising or hosting a DU and/or CU.

Apparatus 7 comprises a processor 701, a program memory 702, a main memory 703, a communication interface 704, and optionally user interface 705, in particular when the apparatus 7 is a UE. In various embodiments, the apparatus 7 comprises further units, parts or structural and/or functional elements.

Apparatus 7 may for instance be configured to perform and/or control or comprise respective means (at least one of 701 to 705) for performing and/or controlling and/or configured to perform the method according to one or more exemplary aspects. Apparatus 7 may as well be an apparatus comprising at least one processor 701 and at least one memory 703 including computer program code, the at least one memory 703 and the computer program code configured to, with the at least one processor 701, cause an apparatus, e.g. apparatus 7 at least to perform and/or control the method according to one or more exemplary aspects.

Processor 701 may for instance further control the memories 702, 703, the communication interface 705, and the optional user interface 705.

Furthermore, processor 701 may for instance execute computer program code stored in program memory 702, which may for instance represent a computer readable storage medium comprising program code that, when executed by processor 701, causes the processor 701 to perform the method according to one or more exemplary aspects.

Processor 701 (and also any other processor mentioned in this specification) may be a processor of any suitable type. Processor 701 may comprise but is not limited to one or more microprocessor(s), one or more processor(s) with accompanying one or more digital signal processor(s), one or more processor(s) without accompanying digital signal processor(s), one or more special-purpose computer chips, one or more field-programmable gate array(s) (FPGA(s)), one or more controller(s), one or more application-specific integrated circuit(s) (ASIC(s)), or one or more computer(s). The relevant structure/hardware may be programmed in such a way to carry out the described function. Processor 701 may for instance be an application processor that runs an operating system.

Program memory 702 may also be separate from or included in processor 701. This memory may for instance be fixedly connected to processor 701, or be at least partially removable from processor 701, for instance in the form of a memory card or stick. Program memory 702 may for instance be non-volatile memory. It may for instance be a FLASH memory (or a part thereof), any of a ROM, PROM, EPROM and EEPROM memory (or a part thereof) or a hard disc (or a part thereof), to name but a few examples. Program memory 702 may also comprise an operating system for processor 701. Program memory 702 may also comprise a firmware for apparatus 7.

Apparatus 7 comprises a working memory 703, for instance in the form of a volatile memory. It may for instance be a Random Access Memory (RAM) or Dynamic RAM (DRAM), to give but a few non-limiting examples. It may for instance be used by processor 701 when executing an operating system and/or computer program.

The communication interface 704 may enable the apparatus 7 to communicate with other entities. The communication interface 704 may for instance comprise a wireless interface, e.g. a cellular radio communication interface and/or a WLAN interface and/or a wire-bound interface, e.g. an IP-based interface, for instance to communicate with entities via the Internet.

User interface 705 is optional and may comprise a display for displaying information to a user and/or an input device (e.g. a keyboard, keypad, touchpad, mouse, etc.) for receiving information from a user.

Some or all of the components of the apparatus 8 may for instance be connected via a bus. Some or all of the components of the apparatus 8 may for instance be combined into one or more modules.

The following embodiments shall also be considered to be disclosed:

### Embodiment 1

A method performed and/or controlled by at least one apparatus, the method comprising:
detecting at least one of a mobility failure and a respective successful handover;
determining a type of the mobility failure, wherein the type of the mobility failure is determined in response to the detected mobility failure;
generating mobility failure information indicative of one or more parameters associated with the type of the mobility failure, wherein the mobility failure information is generated, at least in part, based on the determined type of the mobility failure;
and
providing the mobility failure information and/or successful handover information comprising, at least in part, one or more parameters associated with the respective successful handover, wherein the mobility failure information and/or the successful handover information enable a network to determine whether a root cause associated with at least one of a respective mobility failure information and a respective successful handover information is a misconfiguration of one or more parameters controlling L3 handover procedures or L1/2 inter-cell mobility.

### Embodiment 2

The method of embodiment 1, further comprising:
receiving a handover command indicative of a L1/2 inter-cell change; and/or
receiving a reconfiguration information indicative of one or more parameters controlling L1/2 mobility procedure; and/or
receiving a handover command indicative of one or more parameters controlling L3 mobility procedure.

### Embodiment 3

The method of embodiment 1 or embodiment 2, wherein the apparatus further comprises for the determining of the type of the mobility failure and/or in case of a detected successful handover, one or more of:
i) determining if the mobility failure occurred in a serving cell with no handover command received by the apparatus and prior to the detecting of the mobility failure; and/or
ii) determining if the mobility failure occurred after a handover command is received by the apparatus; and/or
iii) determining if a successful cell change occurred after receiving a handover configuration.

### Embodiment 4

The method of embodiment 3, wherein in case type i) is determined, the generated mobility failure information comprises, at least in part, one or more of the following:
i.a) an indication whether the apparatus was configured with one or more parameters for L1/2 inter-cell mobility;
i.b) one or more physical cell IDs, PCI, of one or more target cells for L1/2 inter-cell mobility;
i.c) one or more pieces of beam measurement information for the serving cell and optionally, for the one or more target cells;
i.d) an indication whether a conditional handover (CHO), is or was configured in addition to L1/2 inter-cell mobility;
ie) one or more L1 measurements for a serving cell and for one or more prepared target cells, if any, that are prepared for L1/2 inter-cell mobility on part of the apparatus.

### Embodiment 5

The method of embodiment 3 or embodiment 4, wherein in case type ii) is determined, the generated mobility failure information comprises, at least in part, one or more of the following:
ii.a) an indication whether a handover command is or was triggered by a L1/2- or a L3-mobility procedure; and
ii.b) an indication about a time duration between the reception of handover command triggering L1 inter-cell mobility execution until the detection of the mobility failure.

### Embodiment 6

The method of any of the embodiments 3 to 5, wherein in case type iii) is determined, the successful handover information comprises, at least in part, one or more of the following:
iii.a) an indication whether a handover command is or was triggered by a L1/2- or a L3-mobility procedure; and
iii.b) an indication about a time duration between a reception of a reconfiguration information for L1/2 inter-cell mobility or the start of L1 beam measurement reporting until a reception of the handover command triggering L1/2 inter-cell mobility execution.

### Embodiment 7

The method of any of the preceding embodiments, further comprising:
starting a timer, wherein the timer is started in response to receiving a handover command, or wherein the timer is started upon reception of a reconfiguration information, or wherein the timer is started upon providing of beam measurement information, and
stopping the timer, wherein the timer is stopped upon detecting of the mobility failure, or wherein the timer is stopped in response to receiving a handover command after the reception of the reconfiguration information.

### Embodiment 8

The method of embodiment 7, wherein the mobility failure information or the successful handover information comprises a duration of the timer.

### Embodiment 9

The method of any of the preceding embodiments, wherein the mobility failure information is part of a radio link failure report message provided by the apparatus, and/or wherein the successful handover information is part of a successful handover report message.

### Embodiment 10

The method of any of the preceding embodiments, wherein the apparatus is a user equipment, or a part of a user equipment.

### Embodiment 11

A method comprising:
being provided with at least one of one or more pieces of mobility failure information indicative of one or more parameters associated with a type of a mobility failure, and one or more pieces of successful handover information comprising, at least in part, one or more parameters associated with a respective successful handover, wherein at least one of a respective mobility failure information and/or a respective successful handover information enable the apparatus to determine whether a root cause associated with at least one of a respective mobility failure information and a respective successful handover information is a misconfiguration of one or more parameters controlling L3 handover procedures or L1/2 inter-cell mobility;
determining whether a cause associated with at least one of a respective mobility failure information and a respective successful handover information is a misconfiguration of one or more parameters controlling L3 handover procedures or L1/2-inter-cell mobility; and
determining adjusted one or more parameters to be used for an upcoming L1/2-inter-cell or L3 handover procedure, wherein the adjusted one or more parameters are determined dependent upon the determined cause.

### Embodiment 12

The method of embodiment 11, wherein the mobility failure occurred in association with an inter-cell handover procedure.

### Embodiment 13

The method of embodiment 11 or embodiment 12, wherein the misconfiguration is related to:
a misconfiguration of one or more parameters controlling L3 handover, or
a misconfiguration of one or more parameters controlling L1/2 inter-cell mobility.

### Embodiment 14

The method of any of the embodiments 11 to 13, wherein the mobility failure occurred in association with a baseline handover (BHO), BHO failure, conditional handover (CHO), CHO failure, or a dual active protocol stack (DAPS) handover or DAPS failure.

### Embodiment 15

The method of embodiment 13 or embodiment 14, wherein the one or more adjusted parameters are determined in response to the cause being a misconfiguration of one or more parameters controlling L1/2 inter-cell mobility.

### Embodiment 16

The method of any of the embodiments 11 to 15, wherein the one or more adjusted parameters are determined such that a controlling of L1/2 inter-cell mobility is optimized.

### Embodiment 17

The method of any of the embodiments 11 to 16, wherein the one or more pieces of mobility failure information are part of one or more radio link failure report messages, and/or wherein the one or more pieces of successful handover information are part of one or more successful handover report messages.

### Embodiment 18

The method of any of the embodiments 11 to 17, wherein the apparatus is a network node providing a serving cell to at least one user equipment, an Access and Mobility Management Function (AMF) element, or a central unit, or a part thereof.

### Embodiment 19

The method of any of the embodiments 11 to 18, further comprising:
forwarding the one or more pieces of mobility failure information and/or the one or more successful handover information to one or more network entities.

### Embodiment 20

The method of any of the embodiments 11 to 19, further comprising:
providing the determined adjusted one or more parameters.

### Embodiment 21

An apparatus configured to perform and/or control or comprising respective means for performing and/or controlling the method of any of the embodiments 1 to 10.

### Embodiment 22

An apparatus configured to perform and/or control or comprising respective means for performing and/or controlling the method of any of the embodiments 11 to 20.

### Embodiment 23

An apparatus comprising at least one processor and at least one memory including computer program code, the at least one memory and the computer program code configured to, with the at least one processor, cause an apparatus at least to perform and/or control the method of any of the embodiments 1 to 10.

### Embodiment 24

An apparatus comprising at least one processor and at least one memory including computer program code, the at least one memory and the computer program code configured to, with the at least one processor, cause an apparatus at least to perform and/or control the method of any of the embodiments 11 to 20.

### Embodiment 25

A tangible computer-readable medium storing computer program code, the computer program code when executed by a processor causing an apparatus to perform and/or control:
detecting at least one of a mobility failure and a respective successful handover;
determining a type of the mobility failure, wherein the type of the mobility failure is determined in response to the detected mobility failure;
generating mobility failure information indicative of one or more parameters associated with the type of the mobility failure, wherein the mobility failure information is generated, at least in part, based on the determined type of the mobility failure;
and
providing the mobility failure information and/or successful handover information comprising, at least in part, one or more parameters associated with the respective successful handover, wherein the mobility failure information and/or the successful handover information enable a network to determine whether a root cause associated with at least one of a respective mobility failure information and a respective successful handover information is a misconfiguration of one or more parameters controlling L3 handover procedures or L1/2 inter-cell mobility.

### Embodiment 26

A tangible computer-readable medium storing computer program code, the computer program code when executed by a processor causing an apparatus to perform and/or control:
being provided with at least one of one or more pieces of mobility failure information indicative of one or more parameters associated with a type of a mobility failure, and one or more pieces of successful handover information comprising, at least in part, one or more parameters associated with a respective successful handover, wherein at least one of a respective mobility failure information and/or a respective successful handover information enable the apparatus to determine whether a root cause associated with at least one of a respective mobility failure information and a respective successful handover information is a misconfiguration of one or more parameters controlling L3 handover procedures or L1/2 inter-cell mobility;
determining whether a cause associated with at least one of a respective mobility failure information and a respective successful handover information is a misconfiguration of one or more parameters controlling L3 handover procedures or L1/2-inter-cell mobility; and
determining adjusted one or more parameters to be used for an upcoming L1/2-inter-cell or L3 handover procedure, wherein the adjusted one or more parameters are determined dependent upon the determined cause.

In the present specification, any presented connection in the described embodiments is to be understood in a way that the involved components are operationally coupled. Thus, the connections can be direct or indirect with any number or combination of intervening elements, and there may be merely a functional relationship between the components.

Moreover, any of the methods, processes and actions described or illustrated herein may be implemented using executable instructions in a general-purpose or special-purpose processor and stored on a computer-readable storage medium (e.g., disk, memory, or the like) to be executed by such a processor. References to a ‘computer-readable storage medium’ should be understood to encompass specialized circuits such as FPGAs, ASICs, signal processing devices, and other devices.

The expression “A and/or B” is considered to comprise any one of the following three scenarios: (i) A, (ii) B, (iii) A and B. Further, the expression “A and/or B” is considered to comprise also the expression “at least one of A and B”. Furthermore, the article “a” is not to be understood as “one”, i.e. use of the expression “an element” does not preclude that also further elements are present. The term “comprising” is to be understood in an open sense, i.e. in a way that an object that “comprises an element A” may also comprise further elements in addition to element A.

It will be understood that all presented embodiments are only exemplary, and that any feature presented for a particular example embodiment may be used with any aspect on its own or in combination with any feature presented for the same or another particular example embodiment and/or in combination with any other feature not mentioned. In particular, the example embodiments presented in this specification shall also be understood to be disclosed in all possible combinations with each other, as far as it is technically reasonable and the example embodiments are not alternatives with respect to each other. It will further be understood that any feature presented for an example embodiment in a particular category (method/apparatus/computer program/system) may also be used in a corresponding manner in an example embodiment of any other category. It should also be understood that presence of a feature in the presented example embodiments shall not necessarily mean that this feature forms an essential feature and cannot be omitted or substituted.

The statement of a feature comprises at least one of the subsequently enumerated features is not mandatory in the way that the feature comprises all subsequently enumerated features, or at least one feature of the plurality of the subsequently enumerated features. Also, a selection of the enumerated features in any combination or a selection of only one of the enumerated features is possible. The specific combination of all subsequently enumerated features may as well be considered. Also, a plurality of only one of the enumerated features may be possible.

The sequence of all method steps presented above is not mandatory, also alternative sequences may be possible. Nevertheless, the specific sequence of method steps exemplarily shown in the figures shall be considered as one possible sequence of method steps for the respective embodiment described by the respective figure.

The subject-matter has been described above by means of example embodiments. It should be noted that there are alternative ways and variations which are obvious to a skilled person in the art and can be implemented without deviating from the scope of the appended claims.

1.-21. (canceled)

22. An apparatus comprising:
means for detecting at least one of a mobility failure and a respective successful handover;
means for determining a type of the mobility failure, wherein the type of the mobility failure is determined in response to the detected mobility failure;
means for generating mobility failure information indicative of one or more parameters associated with the type of the mobility failure, wherein the mobility failure information is generated, at least in part, based on the determined type of the mobility failure; and
means for providing the mobility failure information and/or successful handover information comprising, at least in part, one or more parameters associated with the respective successful handover, wherein the mobility failure information and/or the successful handover information enable a network to determine whether a root cause associated with at least one of a respective mobility failure information and a respective successful handover information is a misconfiguration of one or more parameters controlling L3 handover procedures or L1/2 inter-cell mobility.

23. The apparatus of claim 22, further comprising:
means for receiving a handover command indicative of a L1/2 inter-cell change; and/or
means for receiving a reconfiguration information indicative of one or more parameters controlling L1/2 mobility procedure; and/or
means for receiving a handover command indicative of one or more parameters controlling L3 mobility procedure.

24. The apparatus of claim 22, wherein the apparatus further comprises for the determining of the type of the mobility failure and/or in case of a detected successful handover, one or more of:
i) means for determining if the mobility failure occurred in a serving cell with no handover command received by the apparatus and prior to the detecting of the mobility failure; and/or
ii) means for determining if the mobility failure occurred after a handover command is received by the apparatus; and/or
iii) means for determining if a successful cell change occurred after receiving a handover configuration.

25. The apparatus of claim 24, wherein in case type i) is determined, the generated mobility failure information comprises, at least in part, one or more of the following:
i.a) an indication whether the apparatus was configured with one or more parameters for L1/2 inter-cell mobility;
i.b) one or more physical cell IDs, PCI, of one or more target cells for L1/2 inter-cell mobility;
i.c) one or more pieces of beam measurement information for the serving cell;
i.d) an indication whether a conditional handover (CHO), is or was configured in addition to L1/2 inter-cell mobility;
ie) one or more L1 measurements for a serving cell and for one or more prepared target cells, if any, that are prepared for L1/2 inter-cell mobility on part of the apparatus.

26. The apparatus of claim 24, wherein in case type ii) is determined, the generated mobility failure information comprises, at least in part, one or more of the following:
ii.a) an indication whether a handover command is or was triggered by a L1/2- or a L3-mobility procedure; and
ii.b) an indication about a time duration between the reception of handover command triggering L1 inter-cell mobility execution until the detection of the mobility failure.

27. The apparatus of claim 24, wherein in case type iii) is determined, the successful handover information comprises, at least in part, one or more of the following:
iii.a) an indication whether a handover command is or was triggered by a L1/2- or a L3-mobility procedure; and
iii.b) an indication about a time duration between a reception of a reconfiguration information for L1/2 inter-cell mobility or the start of L1 beam measurement reporting until a reception of the handover command triggering L1/2 inter-cell mobility execution.

28. The apparatus of claim 22, further comprising:
means for starting a timer, wherein the timer is started in response to receiving a handover command, or wherein the timer is started upon reception of a reconfiguration information, or wherein the timer is started upon providing of beam measurement information, and
means for stopping the timer, wherein the timer is stopped upon detecting of the mobility failure, or wherein the timer is stopped in response to receiving a handover command after the reception of the reconfiguration information.

29. The apparatus of claim 28, wherein the mobility failure information or the successful handover information comprises a duration of the timer.

30. The apparatus of claim 22, wherein the mobility failure information is part of a radio link failure report message provided by the apparatus, and/or wherein the successful handover information is part of a successful handover report message.

31. The apparatus of claim 22, wherein the apparatus is a user equipment, or a part of a user equipment.

32. An apparatus comprising:
means for being provided with at least one of one or more pieces of mobility failure information indicative of one or more parameters associated with a type of a mobility failure, and one or more pieces of successful handover information comprising, at least in part, one or more parameters associated with a respective successful handover, wherein at least one of a respective mobility failure information and/or a respective successful handover information enable the apparatus to determine whether a root cause associated with at least one of a respective mobility failure information and a respective successful handover information is a misconfiguration of one or more parameters controlling L3 handover procedures or L1/2 inter-cell mobility;
means for determining whether a cause associated with at least one of a respective mobility failure information and a respective successful handover information is a misconfiguration of one or more parameters controlling L3 handover procedures or L1/2-inter-cell mobility; and
means for determining adjusted one or more parameters to be used for an upcoming L1/2-inter-cell or L3 handover procedure, wherein the adjusted one or more parameters are determined dependent upon the determined cause.

33. The apparatus of claim 32, wherein the mobility failure occurred in association with an inter-cell handover procedure.

34. The apparatus of claim 32, wherein the misconfiguration is related to:
a misconfiguration of one or more parameters controlling L3 handover, or
a misconfiguration of one or more parameters controlling L1/2 inter-cell mobility.

35. The apparatus of claim 32, wherein the mobility failure occurred in association with a baseline handover (BHO), BHO failure, conditional handover (CHO), CHO failure, or a dual active protocol stack (DAPS) handover or DAPS failure.

36. The apparatus of claim 34, wherein the one or more adjusted parameters are determined in response to the cause being a misconfiguration of one or more parameters controlling L1/2 inter-cell mobility.

37. The apparatus of claim 32, wherein the one or more adjusted parameters are determined such that a controlling of L1/2 inter-cell mobility is optimized.

38. The apparatus of claim 32, wherein the one or more pieces of mobility failure information are part of one or more radio link failure report messages, and/or wherein the one or more pieces of successful handover information are part of one or more successful handover report messages.

39. The apparatus of claim 32, wherein the apparatus is a network node providing a serving cell to at least one user equipment, an Access and Mobility Management Function (AMF) element, or a central unit, or a part thereof.

40. The apparatus of claim 32, further comprising:
means for forwarding the one or more pieces of mobility failure information and/or the one or more successful handover information to one or more network entities.

41. The apparatus of claim 32, further comprising:
means for providing the determined adjusted one or more parameters.
